(19) United States
(12) Patent Application Publication
(10) Pub. No.: US 2012/0213958 A1
(43) Pub. Date: Aug. 23, 2012

(54) FLEXIBLE ARTICLE AND METHOD OF FORMING THE ARTICLE

(75) Inventors: Charles S. Golub, Westford, MA (US); Michael J. Tzivanis, Chicopee, MA (US); Clemens E. Zoellner, Bay City, MI (US); Mitchell L. Snyder, Midland, MI (US); Mark F. Colton, Rootstown, OH (US); Duan Li Ou, Watchung, NJ (US)

(73) Assignee: Saint-Gobain Performance Plastics Corporation, Aurora, OH (US)

(21) Appl. No.: 13/368,108

(22) Filed: Feb. 7, 2012

Related U.S. Application Data
(60) Provisional application No. 61/440,246, filed on Feb. 7, 2011.

(51) Int. Cl. B32B 1/08; B29C 47/00; C08K 5/20; B32B 27/40; C08K 5/103

(52) U.S. Cl. 428/36.91; 428/36.9; 524/317; 524/210; 264/209.1

(57) ABSTRACT

A flexible article includes a layer of a thermoplastic polyurethane composition including a plasticizer present at up to about 50.0% by weight of the total weight of the composition. The thermoplastic polyurethane composition has a shore A durometer of not greater than about 80. A method of making a flexible article includes combining a thermoplastic polyurethane with a plasticizer to form a thermoplastic polyurethane composition, wherein the plasticizer is present at up to about 50.0% by weight of the total weight of the composition; and forming the thermoplastic polyurethane composition into the flexible article, wherein the flexible article has a shore A durometer of not greater than about 80.

CROSS-REFERENCE TO RELATED APPLICATION(S)

The present application claims priority from U.S. Provisional Patent Application No. 61/440,246, filed Feb. 7, 2011, entitled “A FLEXIBLE ARTICLE AND METHOD OF FORMING THE ARTICLE,” naming inventors Charles S. Golub, Michael J. Tzivanis, Clemens E. Zoellner, Mitchell L. Snyder, Mark F. Colton, Duan Li Ou, which application is incorporated by reference herein in its entirety.

### FIELD OF THE DISCLOSURE

This disclosure, in general, relates to a flexible article and methods of making the aforementioned flexible article.

### BACKGROUND

Currently, flexible tubing is used to transport any variety of liquids. For food and beverage applications, a silicone-based tubing is a typical material used due to its inherent flexibility, compression set resistance, translucency, and regulatory compliance. Unfortunately, silicone tubing is porous to oxygen and air, which can cause premature spoiling of foods and beverages.

Alternative materials to flexible silicone have been adopted to make flexible articles. Polymers that may be desired typically include those that are flexible, transparent, and appropriate for certain applications. Unfortunately, these polymers may not have all the physical or mechanical properties desired for flexible applications. Further, many of these polymers do not perform well under repeated and long-term applications. As a result, manufacturers are often left to choose the physical and mechanical properties they desire without an option as to whether it can be repeatedly used.

As such, an improved polymeric material is desired.

### SUMMARY

In a particular embodiment, a flexible article includes a layer of a thermoplastic polyurethane composition including a plasticizer present at up to about 50.0% by weight of the total weight of the composition, wherein the thermoplastic polyurethane composition has a shore A durometer of not greater than about 80.

In another exemplary embodiment, a method of making a flexible article includes combining a thermoplastic polyurethane with a plasticizer to form a thermoplastic polyurethane composition, wherein the plasticizer is present at up to about 50% by weight of the total weight of the composition; and forming the thermoplastic polyurethane composition into the flexible article, wherein the flexible article has a shore A durometer of not greater than about 80.

### BRIEF DESCRIPTION OF THE DRAWINGS

The present disclosure may be better understood, and its numerous features and advantages made apparent to those skilled in the art by referencing the accompanying drawings.

FIGS. 1 and 2 include illustrations of exemplary multi-layer tubes.

The use of the same reference symbols in different drawings indicates similar or identical items.

### DETAILED DESCRIPTION

In a particular embodiment, a flexible article includes a thermoplastic polyurethane composition including a plasticizer present at up to about 50.0% by weight of the total weight of the composition. Typically, the flexible article of the thermoplastic polyurethane composition with the plasticizier has a desirable shore A durometer of less than about 80. Further, the thermoplastic polyurethane composition with the plasticizer has a desirable oxygen permeation rate.

The flexible article includes thermoplastic polyurethanes (TPUs). Any reasonable thermoplastic polyurethane is envisioned. Typically, thermoplastic polyurethane is formed by reacting a polyol with an isocyanate. The overall properties of the thermoplastic polyurethane depend upon the type of polyol and isocyanate, crystallinity in the polyurethane, the molecular weight of the polyurethane and chemical structure of the polyurethane backbone. Generally, polyurethanes are either thermoplastic or thermoset, depending on the degree of crosslinking present. Thermoplastic urethanes (TPUs) do not have primary crosslinking while thermoset polyurethanes have a varying degree of crosslinking, depending on the functionality of the reactants.

Thermoplastic polyurethanes are typically based on either methylene diisocyanate (MDI) or toluene diisocyanate (TDI) and include polyester grades of polyols, polyether grades of polyols, or combinations thereof. Any reasonable polyester-based thermoplastic polyurethanes, polyether-based thermoplastic polyurethanes, or combinations thereof are envisioned. In an embodiment, thermoplastic polyurethanes can be formed by a “one-shot” reaction between the isocyanate and the polyol or by a “pre-polymer” system, wherein a curative is added to the partially reacted polyolisocyanate complex to complete the polyurethane reaction. Examples of some common thermoplastic polyurethane elastomers are “TEXIN”, “Desmopan”, tradenames of Bayer Materials Science, “ESTANE”, a tradename of Lubrizol, “PELLETHANE”, a tradename of Dow Chemical Co., “ELASTOLLAN”, a tradename of BASF, Inc. and “Pearlthane”, a tradename of Merquinsa. In an embodiment, the thermoplastic polyurethane is commercially available, for example, from Bayer.

Suitable thermoplastic polyurethanes are those that have a shore A hardness from about 75 to about 95, prior to the addition of any plasticizer. Tensile strength of the thermoplastic polyurethane should be from about 2000 psi to about 9000 psi, prior to the addition of any plasticizer. In an embodiment, thermoplastic polyurethanes which have low melt indexes (MI) and high melt strength may be used. Suitable melt index ranges are from less than 1 g/10 minute to about 20 g/10 minute at 190° C. with an 8.7 kg load, prior to the addition of any plasticizer.

The plasticizer is added to the thermoplastic polyurethane to increase the flexibility of the article, i.e. decrease the shore A durometer of the resulting thermoplastic polyurethane composition. Any suitable plasticizer is envisioned. A suitable plasticizer is, for example, diorthoterephthalate, however other plasticizers such as, bis(2-ethylhexyl)phthalate (DEHP), 1,2-cyclohexane dicarboxylic acid (2-ethylhexyl) ester (DHEH), diisononyl phthalate (DiNP), diisodecyl phthalate (DiDP), monoglycerides of castor oil or linseed oil (COMGHA), dioctyl adipate (DOA), long chain octyl adipate (LCOA), tris(2-ethylhexyl)trimellitate (TOTM), citrates, esters of soybean oil, esters of linseed oil, the like, or combinations thereof, as well as numerous other plasticizers will work to plasticize the TPU system. In a particular embodiment, the plasticizer is added at an amount to decrease the shore A durometer of the resulting thermoplastic polyurethane composition such that the resulting thermoplastic polyurethane composition has a shore A durometer of less than about 80, such as from about 20 to about 80, such as from about 25 to about 75, or even about 40 to about 70. Conventional “soft” grades of thermoplastic polyurethanes typically have a shore A durometer from about 75 to about 95 prior to the addition of any plasticizer. Accordingly, without the use of a plasticizer, a shore A durometer of less than about 75 is uncommon for commercially available thermoplastic polyurethane materials.

Generally, the addition of a plasticizer increases the oxygen permeation rate of the polymer to which it is added. Unexpectedly, it has been discovered that the addition of the plasticizer at an amount of up to about 10.0% by weight of the total composition, such as from about 3.0% to about 10.0% by weight of the total composition, enables the thermoplastic polyurethane composition to maintain a desirable oxygen permeation rate. In an embodiment, the addition of plasticizer at an amount of up to about 20% by weight , such as about 30% by weight, such as about 40% by weight, or even about 50% by weight of the total composition, enables the thermoplastic polyurethane composition to maintain a desirable oxygen permeation rate. In an embodiment, the plasticizer is present in an amount of at least about 2.0% by weight, such as at least about 3.0% by weight, or even at least about 5.0% by weight of the total composition. In an embodiment, the plasticizer is present from about 2.0% to about 20.0% by weight of the total composition. In some embodiments, the thermoplastic polyurethane composition consists essentially of the respective thermoplastic polyurethane and plasticizer described above. As used herein, the phrase “consists essentially of” used in connection with the thermoplastic polyurethane composition precludes the presence of materials that affect the basic and novel characteristics of the thermoplastic polyurethane composition, although, commonly used processing agents and additives such as lubricants, antioxidants, fillers, UV agents, dyes, anti-aging agents, and any combination thereof may be used in the thermoplastic polyurethane composition.

In an embodiment, a lubricant may be used in the thermoplastic polyurethane composition. Any suitable lubricant may be envisioned. Exemplary lubricants include silicone oil, waxes, slip aids, antiblock agents, and the like. Exemplary lubricants further include silicone grafted polyolefin, polyethylene or polypropylene waxes, oleic acid amide, erucamide, stearate, fatty acid esters, and the like. In a particular embodiment, the lubricant is wax such as an amide wax; 1,2-Bis(Octadecanamido)Ethane; Abril wax 10DS; Acrawax C; Acrawax CT; Acrowax C; Advawachs 280; Advawax; Advawax 275; Advawax 280; Armowax ebs-P; Carlisle 280; Carlisle Wax 280; Chemetron 100; Ethylene distearamide; Ethylenebis(stearamide); Ethylenebis(stearylamide); Ethylenebis(stearamide); Ethylenebis(stearylamide); Ethylenebisoctadecanamide; Ethylenebisstearamide; Ethylenebisstearoamide; Ethylenediamine bisstearamide; Ethylenediamine steardiamide; Ethylenedistearamide; Kemamide W 40; Lubrol EA; Microtomic 280; N,N′-Ethylene distearylamide; N,N′-Ethylenebisstearamide; N,N′-1,2-Ethanediylbisoctadecanamide; N,N′-Distearoylethylenediamine; N,N′-Ethylene bisstearamide; N,N′-Ethylene distearylamide; N,N′-Ethylenebis(stearamide); N,N′-Ethylenebis(stearamide); N,N′-Ethylenedi(stearamide), N,N′; Ethylenedistearamide; Nopcowax 22-DS; Octadecanamide, N,N′-1,2; ethanediylbis; Octadecanamide; N,N′-1,2-ethanediylbis; Octadecanamide; N,N′-ethylenebis, Octadecanamide; N,N′-ethylenebis-(8CI); Plastflow; Stearic acid; ethylenediamine diamide; or WAX C; the like, or combinations thereof.

For instance, a lubricant may be used at an amount of less than about 10.0% by weight of the total weight of the composition, such as less than about 5.0% by weight of the total weight of the composition, such as less than about 1.0% by weight of the total weight of the composition, or even less than about 0.3% by weight of the total weight of the thermoplastic polyurethane composition. In an embodiment, the thermoplastic polyurethane composition is substantially lubricant-free. “Substantially lubricant-free” as used herein refers to a thermoplastic polyurethane composition that includes lubricant present at less than about 0.1% by weight of the total weight of the thermoplastic polyurethane composition. For instance, the thermoplastic polyurethane composition may be flexible with the desirable oxygen permeation rate without the addition of a lubricant.

In an exemplary embodiment, the thermoplastic polyurethane composition further includes any additive envisioned such as fillers, antioxidants, UV agents, dyes, pigments, anti-aging agents, or any combination thereof. Exemplary antioxidants include phenolic, hindered amine antioxidants, any combinations thereof, and the like. Exemplary fillers include calcium carbonate, talc, silica, radio-opaque fillers such as barium sulfate, bismuth oxychloride, any combinations thereof, and the like. Typically, an additive may be present at an amount of not greater than about 50% by weight of the total weight of the thermoplastic polyurethane composition, such as not greater than about 40% by weight of the total weight of the thermoplastic polyurethane composition, or even not greater than about 30% by weight of the total weight of the thermoplastic polyurethane composition. Alternatively, the thermoplastic polyurethane composition may be free of fillers and antioxidants.

Typically, the thermoplastic polyurethane composition may be formed into a single layer article or a multilayer article. In an embodiment, the thermoplastic polyurethane composition layer may have a thickness of up to about 100.0 mils. Any thickness may be envisioned.

In an embodiment, the thermoplastic polyurethane composition is formed into a multilayer article. In an exemplary embodiment, the thermoplastic polyurethane composition layer overlies a fluoropolymer layer. Any reasonable fluoropolymer is envisioned. In particular, any fluoropolymer layer suitable for contact with fluids or other material is envisioned. An exemplary fluoropolymer includes a homopolymer, copolymer, terpolymer, or polymer blend formed from a monomer, such as tetrafluoroethylene, hexafluoropropylene, chlorotrifluoroethylene, trifluoroethylene, vinylidene fluoride, vinyl fluoride, perfluoropropyl vinyl ether, perfluoromethyl vinyl ether, or any combination thereof.

The fluoropolymers may include polymers, polymer blends and copolymers including one or more of the above monomers, such as fluorinated ethylene propylene (FEP), ethylene-tretrafluoroethylene (ETFE), poly tetrafluoroethylene-perfluoropropylether (PFA), poly tetrafluoroethylene-perfluoromethylvinylether (MFA), poly tetrafluoroethylene (PTFE), poly vinylidene fluoride (PVDF), ethylene chloro-trifluoroethylene (ECTFE), poly chlorotrifluoroethylene (PCTFE), and tetrafluoroethylene-hexafluoropropylene-vinylidene fluoride (THV). In an embodiment, the fluoropolymer is a poly vinylidene fluoride (PVDF). In further exemplary embodiments, the fluoropolymers may be copolymers of alkene monomers with fluorinated monomers, such as Daikin™ EFEP copolymer by Daikin America, Inc. In an embodiment, the fluoropolymers may include acrylic mixtures.

Generally, the fluoropolymer layer is primarily formed of respective fluoropolymers such that, in the case of polymer blends, non-fluorinated polymers are limited to less than about 50 wt %, such as less than about 15 wt %, less than about 5 wt % or less than about 2 wt % of the total polymer content. In a certain embodiment, the polymer content of the fluoropolymer layer is essentially 100% fluoropolymer. In some embodiments, the fluoropolymer layer consists essentially of the respective fluoropolymers described above. As used herein, the phrase “consists essentially of” used in connection with the fluoropolymers precludes the presence of non-fluorinated polymers that affect the basic and novel characteristics of the fluoropolymer, although, commonly used processing agents and additives such as antioxidants, fillers, UV agents, dyes, pigments, anti-aging agents, and any combination thereof may be used in the fluoropolymer layer.

In one particular embodiment, the fluoropolymers may be copolymers formed of the monomers TFE, HFP, and VDF, such as THV copolymer. The THV copolymer may include Dyneon™ THV 220, Dyneon™ THV 2030GX, Dyneon™ THV 500G, Dyneon™ THV X815G, or Dyneon™ THV X610G. For example, the copolymer may include about 20-70 wt % VDF monomer, such as about 35-65 wt % VDF monomer. The copolymer may include about 15-80 wt % TFE monomer, such as about 20-55 wt % TFE monomer. In addition, the copolymer may include about 15-75 wt % HFP monomer, such as about 20-65 wt %.

The total thickness of the multilayer article may be from about 2 mils to about 500 mils, such as from about 50 mils to about 100 mils. In an embodiment, the fluoropolymer layer has a thickness from about 1 mil to about 40 mils, such as from about 3 mils to about 10 mils, or from about 1 mil to about 2 mils. Any reasonable thickness for the multiple layers may be envisioned.

In an embodiment, a tie layer may be used to increase the adhesion of the thermoplastic polyurethane composition layer to the fluoropolymer layer. Any adhesive, primer, or tie layer material may be envisioned. Exemplary adhesive materials include thermoset polymers and thermoplastic polymers. For instance, the thermoplastic material may include thermoplastic elastomers such as cross-linkable elastomeric polymers of natural or synthetic origin. In an embodiment, the tie layer may be a blend of a thermoplastic polyurethane and a fluoropolymer as described above, respectively. For instance, the fluoropolymer is present in the blend from about 5.0% to about 60.0% by weight of the total weight of the tie layer blend. The blend of the fluoropolymer and the thermoplastic polyurethane provides an inherent tie layer such that the blend adheres without delamination to both the thermoplastic polyurethane composition layer and the fluoropolymer layer. In an embodiment, the fluoropolymer in the blend is a poly-vinylidene fluoride (PVDF). In an embodiment, the thermoplastic polyurethane in the blend may be plasticized. In another embodiment, the thermoplastic polyurethane in the blend may be free of a plasticizer.

In a further embodiment, the tie layer includes a thermoplastic material having a melt temperature not greater than about 550° F. In an embodiment, the tie layer includes a thermoplastic material having a melt temperature not greater than about 350° F., such as not greater than about 400° F., such as not greater than about 450° F. In an embodiment, the tie layer includes a thermoplastic material having a melt temperature greater than about 500° F.

The tie layer may have any reasonable thickness in the multilayer article. Typically, the tie layer has a thickness of less than about 5.0 mils. For example, the thickness of the tie layer may be in a range of about 0.2 mils to about 1.0 mil. In an embodiment, the flexible article is free of any tie layer.

The components of the thermoplastic polyurethane composition may be melt processed by any known method to form the resulting thermoplastic polyurethane material. In an embodiment, the thermoplastic polyurethane and plasticizer may be melt processed by dry blending or compounding. The dry blend may be in powder, granular, or pellet form. The thermoplastic polyurethane composition can be made by a continuous twin-screw compounding process or batch related process. Pellets of the thermoplastic polyurethane composition may then be fed into a single screw extruder to make flexible articles. The components can also be mixed in a single-screw extruder equipped with mixing elements and then extruded directly into flexible articles such as tubing products. In an embodiment, the thermoplastic polyurethane composition can be melt processed by any method envisioned known in the art such as laminating, casting, molding, and the like. In an embodiment, the thermoplastic polyurethane composition can be injection molded. In an embodiment, the thermoplastic polyurethane composition layer has a major surface that is treated to increase the adhesion of the major surface. The treatment may include surface treatment, chemical treatment, sodium etching, corona treatment, plasma treatment, or any combination thereof. In an embodiment, the thermoplastic polyurethane composition layer is free of any surface treatment.

In a particular embodiment, a flexible article may be provided that includes providing a thermoplastic polyurethane composition layer overlying a fluoropolymer layer. Any reasonable method of providing the fluoropolymer layer is envisioned and is typically dependent upon the fluoropolymer used. For instance, the fluoropolymer layer may be cast, extruded, or skived. In an embodiment, the fluoropolymer layer may be extruded. In an exemplary embodiment, the fluoropolymer layer may be co-extruded with the thermoplastic polyurethane composition layer. In an embodiment, the fluoropolymer layer has a major surface that is treated to increase the adhesion of the major surface. The treatment may include surface treatment, chemical treatment, sodium etching, corona treatment, plasma treatment, or any combination thereof. In an embodiment, the fluoropolymer layer is free of any surface treatment.

When present, the application of the tie layer is typically dependent upon the material used. Any reasonable method of applying the tie layer is envisioned. In an embodiment, the tie layer may be extruded, melted, laminated, applied in a liquid state and dried or cured, and the like. For instance, a thermoplastic adhesive may be applied in one step or multiple steps. In an embodiment, when the tie layer is a blend of the fluoropolymer and the thermoplastic polyurethane, the blend may be extruded. In an exemplary embodiment, the blend may be co-extruded with the fluoropolymer layer, the thermoplastic polyurethane composition layer, or any combination thereof. Where the tie layer is a thermoset material, the assembly is typically done in one process, with the liquid adhesive applied to one or more of the layers which are then brought together; heat may or may not be used to cure the thermosetting adhesive. Any reasonable method of curing the adhesive may be used and is typically dependent upon the material chosen.

In an embodiment, any flexible article can be made out of the thermoplastic polyurethane composition, depending on specific application needs. The flexible article can be any useful shape such as film, sheet, tubing, and the like. In an embodiment, the flexible article is a nozzle, a closure, a tube, a valve, a bag, or combination thereof. In an exemplary embodiment, the flexible article is tubing for peristaltic pump applications. Exemplary articles include single layer structures and multi-layer structures. Multi-layer articles may include any reasonable additional layers such as reinforcing layers, adhesive layers, barrier layers, chemically resistant layers, sensing layers (i.e. metal layers), any combination thereof, and the like. In an embodiment, at least one optional layer in a multilayer article can be used that can regulate various article properties including, but not limited to, improved permeation resistance, improved stiffness, and improved burst strength compared to an article that does not contain the at least one optional layer. Any reasonable layer may be used to improve the permeation resistance such as an EVOH layer, nylon layer, the like, or combinations thereof. Any reasonable layer may be used to improve the stiffness of the multilayer article such as with the addition of a fiber, fabric, or metal reinforcement layer. Any reasonable layer may be used to improve the burst strength of the multilayer article such as with the addition of a fabric or metal reinforcement layer.

In a particular embodiment, the thermoplastic polyurethane composition may be used to produce tubing and hoses. For instance, the thermoplastic polyurethane composition can be used as tubing or hosing to produce low toxicity pump tubing, chemically resistant hosing, low permeability hosing and tubing, peristaltic pump tubing, and the like. For instance, tubing may be provided that has any useful diameter size for the particular application chosen. In an embodiment, the tubing may have an outside diameter (OD) of up to about 2.0 inches, such as up to about 0.25 inch, up to about 0.50 inch, and up to about 1.0 inch. Tubing of the thermoplastic polyurethane composition advantageously exhibits desired properties such as chemical stability and increased lifetime in applications where back pressure is introduced. For example, the tube may have a pump life greater than about 80 hours while pumping under greater than about 100 psi back pressure, or even greater as measured at 100 RPM using a standard peristaltic pump head.

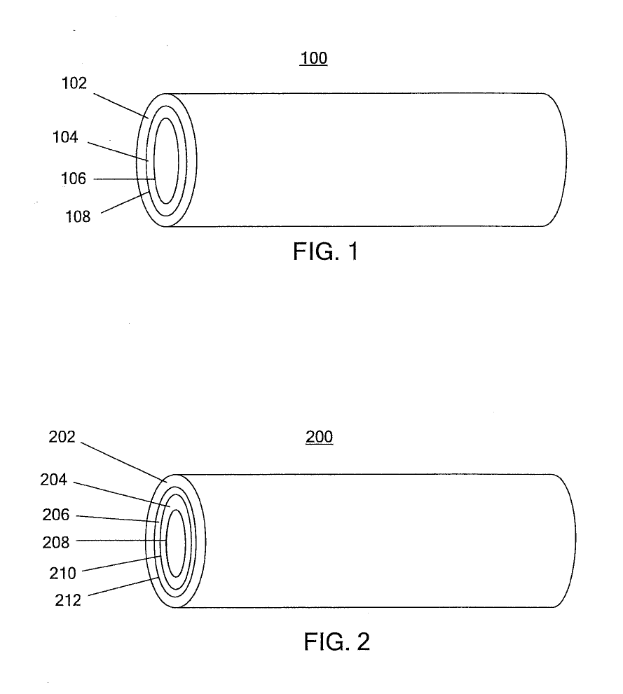

As illustrated in FIG. 1, a multi-layer tube 100 is an elongated annular structure having a hollow central bore. The multi-layer tube 100 includes a thermoplastic polyurethane composition layer 102 and a fluoropolymer layer 104. The fluoropolymer layer 104 includes an inner surface 106 that defines a central lumen of the tube. The thermoplastic polyurethane composition layer 102 may be directly in contact with and may directly bond to the fluoropolymer layer 104 along an outer surface 108 of the fluoropolymer layer 104. For example, the thermoplastic polyurethane composition layer 102 may directly bond to the fluoropolymer layer 104 without intervening tie layers. In an exemplary embodiment, the multi-layer tube 100 includes two layers, such as the thermoplastic polyurethane composition layer 102 and the fluoropolymer layer 104.

Alternatively, a multi-layer tube 200 may include two or more layers, such as three layers. For example, FIG. 2 illustrates a tie layer 206 sandwiched between the fluoropolymer layer 204 and thermoplastic polyurethane composition layer 202. The fluoropolymer layer 204 includes an inner surface 208 that defines a central lumen of the tube. In an exemplary embodiment, the tie layer 206 is directly in contact with and may be directly bonded to the outer surface 210 of the fluoropolymer layer 204. In such an example, the tie layer 206 may directly contact and may be directly bonded to thermoplastic polyurethane composition layer 202 along an outer surface 212 of the tie layer 206. Although not illustrated, an embodiment includes at least one optional layer disposed within the tube 200 that can regulate various properties including, but not limited to, permeation resistance (i.e. an addition of an EVOH or Nylon layer), stiffness (i.e. an addition of a fiber, fabric or metal reinforcement layer(s)), and burst strength (i.e. an additional of a fabric or metal reinforcement layer(s)). In an embodiment, at least one property is improved with the use of at least one optional layer compared to a tube without the optional layer.

In embodiment, the flexible articles may have further desirable physical and mechanical properties. For instance, the flexible articles are kink-resistant and appear transparent or at least translucent. In particular, the flexible articles have desirable flexibility, substantial clarity or translucency, desirable oxygen permeability, and chemical resistance. For instance, the flexible articles of the thermoplastic polyurethane composition may advantageously produce low durometer articles. For example, a thermoplastic polyurethane composition having a Shore A durometer of less than about 80, such as from about 20 to about 80, or even from about 40 to about 70 having desirable mechanical properties may be formed. Such properties are indicative of a flexible material.

In addition to desirable hardness, the flexible articles have advantageous permeability properties. In an embodiment, the thermoplastic polyurethane composition has a desirable oxygen permeation rate. In an embodiment, the thermoplastic polyurethane composition has an oxygen permeation rate of less than about 500,000 [cc O₂-mil]/[m²-day], such as less than about 400,000 [cc O₂-mil]/[m²-day], such as less than about 300,000 [cc O₂-mil]/[m²-day], such as less than about 200,000 [cc O₂-mil]/[m²-day], or even less than about 100,000 [cc O₂ -mil]/[m²-day]. For instance, the thermoplastic polyurethane composition has an oxygen permeation rate from about 38,000 [cc O₂-mil]/[m²-day] to about 100,000 [cc O₂-mil]/[m²-day]. The thermoplastic polyurethane composition provides a flexible article that has minimal permeation to oxygen for storage and transport of oxygen sensitive materials, specifically liquids intended for human consumption, for up to about 30 days, up to about 50 days, or even up to about 90 days.

The flexible articles have advantageous physical properties, such as desirable maximum elongation and Young's modulus. Maximum elongation is determined using an Instron instrument in accordance with AS™ D638 testing methods. For example, the flexible articles may exhibit a maximum elongation of at least about 1300%, such as at least about 1500%. In an embodiment, the Young's modulus is from about 2.5 MPa to about 15 MPa.

Applications for the thermoplastic polyurethane composition are numerous. In particular, the non-toxic nature of the thermoplastic polyurethane composition makes the material useful for any application where toxicity is undesired. For instance, the thermoplastic polyurethane composition has potential for FDA, USP, and other regulatory approvals. In an exemplary embodiment, the thermoplastic polyurethane composition may be used in applications such as industrial, medical, health care, biopharmaceutical, drinking water, food & beverage, laboratory, wastewater, and the like. In an embodiment, the article is for water treatment, digital print equipment, medical, pharmaceutical, laboratory, automotive, or other applications where chemical resistance, and/or low permeation to gases and hydrocarbons, and/or high purity are desired. In an embodiment, a high purity article has low leachables and extractables.

### EXAMPLES

To make flexible articles, four samples are prepared by combining a thermoplastic polyurethane with a plasticizer and lubricant. The thermoplastic polyurethane is DP7-1209, available from Bayer. The plasticizer is Eastman 168 and the lubricant is an amide wax. The shore A durometer of the thermoplastic polyurethane prior to the addition of plasticizer and lubricant is 75 shore A. The TPU is dried in a Conair desiccant dryer for about 4-12 hours at about 80° C. Both the primary amide wax and the TPU are strave fed through a gravimetric feeder at the feed throat of a twin screw extruder. The twin screw is an 11 segment 44/1 L/D extruder with a vent port in the 11th barrel segment and a feed section for liquid injection in the 8^{th} segment. Liquid injection is used is to inject the plasticizer into the molten polymer. The temperature setting of the twin screw is shown below. A microdispersion of polyethylene wax was used to assist in reducing tackiness of the strands. The wax was in a separate 1′ long cooling bath at the end of the 8′ long primary cooling bath. Tables 1 and 2 illustrate the conditions and Table 3 illustrates the amount of the components in the composition.

TABLE 1

| Twin Screw Settings | | | Temperature ° F. | | | | | | | |
|---|---|---|---|---|---|---|---|---|---|---|
| Z1 | Z2 | Z3 | Z4 | Z5 | Z6 | Z7 | Z8 | Z9 | Z10 | Z11 |
| 380 | 380 | 380 | 380 | 380 | 380 | 380 | 375 | 375 | 375 | 375 |

TABLE 2

| Melt Temperature | 425° | F. |
|---|---|---|
| Die Pressure | 40 | psi |
| Extruder Torque | 69 | |
| Residence Time | 27 | seconds |
| Liquid feed rate | 25 | #'s/hr |

TABLE 3

| | Thermoplastic | | |
|---|---|---|---|
| | Polyurethane | Plasticizer | Lubricant |
| Sample | (% total weight) | (% total weight) | (% total weight) |
| 1 | 96.97 | 3.0 | 0.03 |
| 2 | 89.97 | 10.0 | 0.03 |
| 3 | 92.47 | 7.5 | 0.03 |
| 4 | 94.97 | 5.0 | 0.03 |

An exemplary thermoplastic polyurethane composition containing a plasticizer and a lubricant is tested for mechanical and physical properties. The samples are molded into 2 mm thick slabs and dog bone testing specimens are cut out of the slabs for testing. Results can be seen in Table 4.

TABLE 4

| Property | Result | Reference |
|---|---|---|
| Appearance | Translucent | Visual |
| Density | 1.06 g/cm³ | SOP (helium |
| | | pycnometry) |
| Melt temperature | 180° C.-210° C. | D.S.C. |
| Durometer, Shore A | 65-73 | ASTM D2240 |
| | | (after 15 sec.) |
| Young's Modulus | 2.5 MPa-15.0 MPa | ASTM D638 |
| 100% Modulus | 2.75 MPa-4.0 MPa | ASTM D638 |
| 300% Modulus | 1.75 MPa-3.0 MPa | ASTM D638 |
| Maximum Elongation | 1300% (minimum) | ASTM D638 |
| O₂ Permeation rate | 38,000-100,000 | ASTM D3985 |
| | [cc O₂-mil]/[m²-day] | |

Clearly, the shore A durometer is decreased with the use of a plasticizer. The resulting samples have desirable properties for flexible article applications. In particular, the resulting samples have properties that exhibit elongation and modulus for repeated and long-term applications, such as peristaltic pump applications.

The samples of the thermoplastic polyurethane composition are tested for oxygen permeation rate. Oxygen transmission rate is tested on a MOCON OX-tran2/21H O₂ analyzer at room temperature (about 23° C.) with a carrier gas of 4% H₂/96% N₂ at a flow rate of 10 sccm. The test gas is 100% O₂ with a test area of 5 cm² for a 30 minute cycle. Results can be seen in Table 5.

TABLE 5

| | Thick- | Thick- | Transmission | Permeation |
|---|---|---|---|---|
| | ness | ness | rate | rate |
| Sample | (mm) | (mil) | [cc O₂]/[m²-day] | [cc O₂-mil]/[m²-day] |
| 156 | 1.927 | 75.8 | 504 | 38,211 |
| 157 | 1.865 | 73.4 | 1210 | 91,793 |
| 158 | 1.865 | 73.4 | 1284 | 94,286 |
| 159 | 1.865 | 73.4 | 1138 | 83,561 |
| 160 | 1.865 | 73.4 | 721 | 52,914 |

Comparison is made to commercially available silicone and thermoplastic polyurethane (without plasticizer) samples. Oxygen permeation rates can be seen in Table 6.

TABLE 6

| | Average permeation rate | Crosslink density |
|---|---|---|
| Sample | [cc O₂-mil]/[m²-day] | Mc (g/mol) |
| HCR silicone 1 | 750,000 | 4219 (96) |
| HCR silicone 2 | 1,381,200 | 3180 (126) |
| HCR silicone 3 | 1,095,500 | 4517 (59) |
| Estane 58213 (TPU) | 12,800 | n/a |

The thermoplastic polyurethane composition with the addition of the plasticizer has an improved oxygen permeation rate compared to commercially available silicone. An average permeation rate of greater than about 650,000 [cc O₂-mil]/[m²-day] is undesirable for oxygen sensitive foods and beverages. Compared to a commercially available thermoplastic polyurethane without any plasticizer, the oxygen permeation rate of the thermoplastic polyurethane composition with plasticizer is still well within acceptable limits. The combination of flexibility and desirable oxygen permeation rate makes the thermoplastic polyurethane composition particularly useful for the applications discussed above.

An exemplary thermoplastic polyurethane composition containing a plasticizer is tested for mechanical and physical properties. The samples are molded into 2mm thick slabs and dog bone testing specimens are cut out of the slabs for testing. Results can be seen in Table 7.

TABLE 7
Brabending of TPU and Plasticizer

| | | | | | Young's | 100% | 300% | |
|---|---|---|---|---|---|---|---|---|
| Run | | % by | | % by | modulus | modulus | modulus | Max. |
| # | TPU | weight | Plasticizer | weight | (MPa) | (MPa) | (MPa) | Strain (%) |
| 1 | Texin | 100 | COMGHA | 0 | 12.82 | 5.02 | 2.99 | 461.1 |
| | DP1201 | | | | | | | |
| 2 | Texin | 92.5 | COMGHA | 7.5 | 10.94 | 4.39 | 2.54 | 437.13 |
| | DP1201 | | | | | | | |
| 3 | Texin | 85 | COMGHA | 15 | 8.3 | 3.35 | — | 153.02 |
| | DP1201 | | | | | | | |
| 4 | Texin | 77.5 | COMGHA | 22.5 | 6.24 | 2.55 | — | 126.35 |
| | DP1201 | | | | | | | |
| 5 | Texin | 70 | COMGHA | 30 | 5.25 | 2.81 | 1.77 | 649.08 |
| | DP1201 | | | | | | | |
| 6 | Desmopan | 100 | COMGHA | 0 | 8.51 | 2.69 | 1.54 | 838.26 |
| | 9370 | | | | | | | |
| 7 | Demopan | 92.5 | COMGHA | 7.3 | 6.29 | 2.59 | 1.68 | 887.11 |
| | 9370 | | | | | | | |
| 8 | Desmopan | 85 | COMGHA | 15 | 6.08 | 2.42 | 1.52 | 1004.77 |
| | 9370 | | | | | | | |
| 9 | Desmopan | 77.5 | COMGHA | 22.5 | 4.37 | 1.93 | 1.26 | 803.26 |
| | 9370 | | | | | | | |
| 10 | Desmopan | 70 | COMGHA | 30 | 3.5 | 1.51 | 0.98 | 698.88 |
| | 9370 | | | | | | | |

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A flexible article comprising a layer of a thermoplastic polyurethane composition including a plasticizer present at up to about 50.0% by weight of the total weight of the composition, wherein the thermoplastic polyurethane composition has a shore A durometer of not greater than about 80.

2. The flexible article of claim 1, wherein the thermoplastic polyurethane includes polyester-based polyurethane, polyether-based polyurethane, or combinations thereof.

3. The flexible article of claim 1, wherein the plasticizer is diorthoterephthalate, DEHP, DHEH, DiNP, DiDP, COMGHA, DOA, LCOA, TOTM, citrates, esters of soybean oil, esters of linseed oil, or combinations thereof.

4. (canceled)

5. (canceled)

6. (canceled)

7. The flexible article of claim 1, wherein the composition further includes a lubricant.

8. The flexible article of claim 7, wherein the lubricant is an amide wax;1,2-Bis(Octadecanamido) Ethane; Abril wax 10DS; Acrawax C; Acrawax CT; Acrowax C; Advawachs 280; Advawax; Advawax 275; Advawax 280; Armowax ebs-P; Carlisle 280; Carlisle Wax 280; Chemetron 100; Ethylene distearamide; Ethylenebis(stearamide); Ethylenebis(stearylamide); Ethylenebis(stearamide); Ethylenebis(stearylamide); Ethylenebisoctadecanamide; Ethylenebisstearamide; Ethylenebisstearoamide; Ethylenediamine bisstearamide; Ethylenediamine steardiamide; Ethylenedistearamide; Kemamide W 40; Lubrol EA; Microtomic 280; N,N′-Ethylene distearylamide; N,N′-Ethylenebisstearamide; N,N′-1,2-Ethanediylbisoctadecanamide; N,N′-Distearoylethylenediamine; N,N′-Ethylene bisstearamide; N,N′-Ethylene Distearylamide; N,N′-Ethylenebis(stearamide); N,N′-Ethylenebis(stearamide); N,N′-Ethylenedi(stearamide), N,N′; Ethylenedistearamide; Nopcowax 22-DS; Octadecanamide, N,N′-1,2; ethanediylbis; Octadecanamide; N,N′-1,2-ethanediylbis; Octadecanamide; N,N′-ethylenebis, Octadecanamide; N,N′-ethylenebis-(8CI); Plastflow; Stearic acid; ethylenediamine diamide; WAX C, or combinations thereof.

9. (canceled)

10. (canceled)

11. The flexible article of claim 1, wherein the thermoplastic polyurethane composition has an oxygen permeation rate from about 38,000 [cc O2-mil]/[m2-day] to about 100,000 [cc O2-mil]/[m2-day].

12. The flexible article of claim 1, having substantial transparency.

13. The flexible article of claim 1, wherein the article is tubing having an inner surface defining a lumen therethrough.

14. The flexible article of claim 13, further comprising an inner layer of a fluoropolymer, wherein the thermoplastic polyurethane composition layer overlies the inner layer.

15. (canceled)

16. The flexible article of claim 14, further comprising a tie layer disposed between the inner fluoropolymer layer and the thermoplastic polyurethane layer.

17. The flexible article of claim 16, wherein the tie layer is a blend of a thermoplastic polyurethane and a fluoropolymer.

18. (canceled)

19. (canceled)

20. (canceled)

21. The flexible article of claim 1, wherein the article is a nozzle, a closure, a tube, a valve, a film, a bag, or combination thereof.

22. (canceled)

23. A method of making a flexible article comprising:
combining a thermoplastic polyurethane with a plasticizer to form a thermoplastic polyurethane composition, wherein the plasticizer is present at up to about 50.0% by weight of the total weight of the composition; and
forming the thermoplastic polyurethane composition into the flexible article, wherein the flexible article has a shore A durometer of not greater than about 80.

24. The method of claim 23, wherein the thermoplastic polyurethane includes polyester-based polyurethane, polyether-based polyurethane, or combinations thereof.

25. The method of claim 23, wherein the plasticizer is diorthoterephthalate, DEHP, DHEH, DiNP, DiDP, COMGHA, DOA, LCOA, TOTM, citrates, esters of soybean oil, esters of linseed oil, or combinations thereof.

26. (canceled)

27. (canceled)

28. (canceled)

29. The method of claim 23, wherein combining further comprises adding a lubricant to the thermoplastic polyurethane composition.

30. (canceled)

31. (canceled)

32. (canceled)

33. (canceled)

34. (canceled)

35. The method of claim 23, wherein the flexible article is formed by injection molding, extrusion, or combination thereof.

36. The method of claim 23, wherein article is a flexible tube has an inner surface defining a lumen therethrough.

37. The method of claim 36, further comprising providing an inner layer of a fluoropolymer, wherein the thermoplastic polyurethane composition layer is extruded over the inner layer.

38. (canceled)

39. (canceled)

40. The method of claim 37, further comprising providing a tie layer disposed between the inner fluoropolymer layer and the thermoplastic polyurethane composition layer.

41. (canceled)

42. (canceled)

43. (canceled)

44. (canceled)

45. (canceled)

46. (canceled)

47. (canceled)

48. (canceled)
